(19) United States
(12) Patent Application Publication
(10) Pub. No.: US 2026/0030010 A1
(43) Pub. Date: Jan. 29, 2026

(54) STORAGE MEDIUM, CONTROL METHOD, AND INFORMATION PROCESSING APPARATUS

(71) Applicant: CANON KABUSHIKI KAISHA, Tokyo (JP)

(72) Inventor: HIROSHI KIKUCHI, Kanagawa (JP)

(21) Appl. No.: 19/268,637

(22) Filed: Jul. 14, 2025

(30) Foreign Application Priority Data
Jul. 29, 2024 (JP) 2024-122444

(51) Int. Cl. G06F 8/61

(52) U.S. Cl. CPC G06F 8/61

(57) ABSTRACT

A non-transitory computer-readable storage medium storing a program that causes an information processing apparatus to perform a method, the program being for installing a driver for controlling a peripheral apparatus on the information processing apparatus, the method including obtaining a certificate of the driver in a case where the certificate is not installed on the information processing apparatus, installing the obtained certificate on the information processing apparatus, and installing the driver in response to installation of the certificate.

### BACKGROUND

### Field of the Technology

The present disclosure relates to an information processing apparatus that installs a driver, a control method, and a storage medium.

### Description of the Related Art

A typical example of a print control program that controls a printer is a Windows® printer driver. A driver package for the Windows® printer driver includes a catalog (CAT) file. As described in Japanese Patent Laid-Open No. 2014-48956, a digital signature can be added to the CAT file to prevent the driver from being tampered with.

The digital signature is obtained by encrypting a hash value of a file group included in the driver package with a secret key. The hash value may be extracted by decrypting the digital signature with a public key, and it is possible to verify whether contents of each file in the driver package have not been changed by comparing the extracted hash value with an actual hash value of the driver package.

A catalog file includes a certificate. A certificate of a trusted issuer of an electronic signature (digital signature) is stored in a certificate store of an information processing apparatus.

At the time of installation of a printer driver on an information processing apparatus, some operating systems (OS) display a screen prompting a user to confirm whether to proceed with installation of the printer driver, depending on an issuer of an electronic signature attached to a CAT file. For example, in a case where a certificate corresponding to an electronic signature is not stored in the certificate store, a confirmation screen is displayed.

The method described in Japanese Patent Laid-Open No. 2014-48956 has a usability issue that the confirmation screen may be displayed at the time of driver installation. Even though a user executes an installer of an obtained driver so that an intention of the user of installing the driver is clear, it is unnecessary to display the confirmation screen for a confirmation of whether the driver is to be installed at the time of installation of the driver.

### SUMMARY

The present disclosure is directed to improvements of operability at the time of driver installation.

According to an aspect of the present disclosure, a non-transitory computer-readable storage medium storing a program that causes an information processing apparatus to perform a method, the program being for installing a driver for controlling a peripheral apparatus on the information processing apparatus, the method including obtaining a certificate of the driver in a case where the certificate is not installed on the information processing apparatus, installing the obtained certificate on the information processing apparatus, and installing the driver in response to installation of the certificate.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a system configuration.

FIG. 2 is a diagram illustrating a hardware configuration of a computer.

FIG. 3 is a diagram illustrating a software configuration of the computer.

FIG. 4 is a diagram illustrating a file structure of an installation package for a driver according to a first embodiment.

FIG. 5 is a diagram illustrating a transition of screens that are displayed by an installer.

FIG. 6 is a diagram illustrating a security warning screen that is displayed by an operation system (OS).

FIG. 7 is a diagram illustrating a processing procedure of the installer according to the first embodiment.

FIG. 8 is a diagram illustrating a screen that is displayed by the installer according to the first embodiment.

FIG. 9 is a diagram illustrating a file structure of an installation package for a driver according to a second embodiment.

FIG. 10 is a diagram illustrating a processing procedure of an installer according to the second embodiment.

FIG. 11 is a diagram illustrating a screen that is displayed by the installer according to the second embodiment.

### DESCRIPTION OF THE EMBODIMENTS

### First Embodiment

Hereinafter, embodiments of the present disclosure will be described with reference to the drawings.

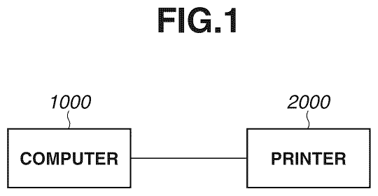

FIG. 1 is a diagram illustrating a connection configuration including a computer 1000 serving as an example of an information processing apparatus and a printer 2000 serving as an example of a peripheral apparatus in a printing system according to the present embodiment. Examples of the computer 1000 include a personal computer (PC), a smartphone, and a tablet terminal. The computer 1000 and the printer 2000 are connected to each other via a network, a USB, or the like, and can communicate with each other.

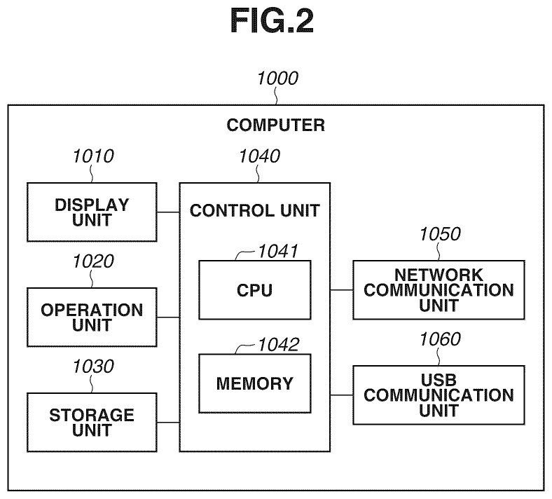

FIG. 2 is a block diagram illustrating a hardware configuration of the computer 1000.

A control unit 1040 including a central processing unit (CPU) 1041 and a memory 1042 controls operation of the computer 1000. A display unit 1010 is an output device, such as a display, and an operation unit 1020 is an input device, such as a mouse, a keyboard, or a touch panel.

A storage unit 1030 is a storage medium, such as a hard disk or a solid-state drive (SSD) and stores various types of software to be used for the computer 1000 to operate. An operation system (OS) 1110 and a driver, which will be described below, are also stored in the storage unit 1030. A network communication unit 1050 is connected to the network to input and output data to and from an external apparatus. A universal serial bus (USB) communication unit 1060 inputs and outputs data to and from an external apparatus via a USB connection. The computer 1000 and the printer 2000 are connected via the network communication unit 1050 or the USB communication unit 1060.

Software processing in the present embodiment is realized by loading software stored in the storage unit 1030 into the memory 1042 in the control unit 1040 and executing the software by the CPU 1041.

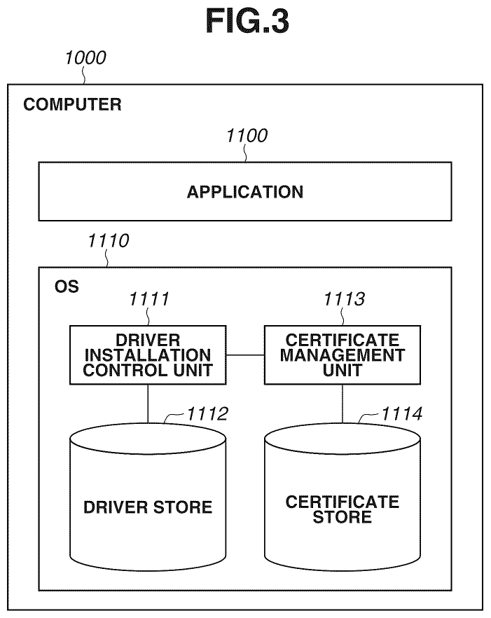

FIG. 3 is a block diagram illustrating a software configuration of the computer 1000, which is related to driver installation processing of the present embodiment. The software illustrated in FIG. 3 is stored in the storage unit 1030. An application 1100 refers to any software, such as document creation software or spreadsheet software, and an installer 1210 of a driver described below is also included in the application 1100.

The OS 1110 is software that controls basic operation of the computer 1000. The OS 1110 includes a driver installation control unit 1111 and a certificate management unit 1113, and includes data areas called a driver store 1112 and a certificate store 1114.

The driver installation control unit 1111 performs control to install a driver, which has been prepared outside the OS 1110, on the OS 1110. A driver is software that enables the computer 1000 to control peripherals like the printer 2000. A printer driver is generally supplied by a vendor that manufactures the printer 2000. Installing the printer driver on the OS 1110 includes adding the driver supplied by the vendor to the OS 1110 to enable the printer 2000 to be usable from the computer 1000 under control of the OS 1110.

The driver installation control unit 1111 verifies a driver to be installed and stores the driver in the driver store 1112. Thus, drivers for a wide variety of peripheral apparatuses are stored in the driver store 1112. The certificate management unit 1113 manages certificates registered in the OS 1110. The certificate store 1114 is managed by the certificate management unit 1113 and stores various certificates used by the OS 1110.

In the present embodiment, the certificate is used to prove validity of a digital signature, and the relationship between the digital signature and the certificate may be similar to the relationship between a personal seal and a seal registration certificate. A certificate of an issuer who is trusted by an administrator or a user of the computer 1000 is stored in the certificate store 1114.

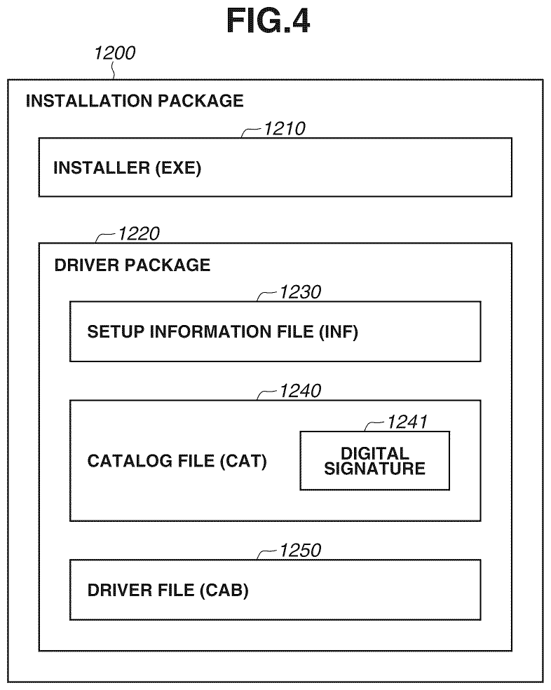

FIG. 4 is a diagram illustrating a file structure of an installation package 1200 of a driver in the present embodiment. The installation package 1200 is a file group supplied by the vendor and includes files described below.

The installer 1210 (executable (EXE) file) is the application 1100 for installing a driver and installs a driver file 1250 (cabinet (CAB) file) on the OS 1110 in response to a user with administrator authority executing the installer 1210.

A driver package 1220 is a driver-related file group in the pre-installation state and includes a setup information file 1230 (information (INF) file), a catalog file 1240 (catalog (CAT) file), and the driver file 1250.

The setup information file 1230 describes information to be used for installation of the driver file 1250. Specifically, the setup information file 1230 describes a type and a version of the driver, a file name of the catalog file 1240, a file name and an installation destination of the driver file 1250, and the like.

The catalog file 1240 is a file used when the driver file 1250 is installed and to verify driver package 1220. The catalog file 1240 includes a digital signature 1241 and a certificate of the driver file 1250, and is used to check whether the driver file 1250 that has been signed has not been tampered with.

The driver file 1250 is a main body of the driver to be installed and is a file in which an executable program, a data file, and the like for controlling a peripheral apparatus are compressed.

### CONVENTIONAL EXAMPLE

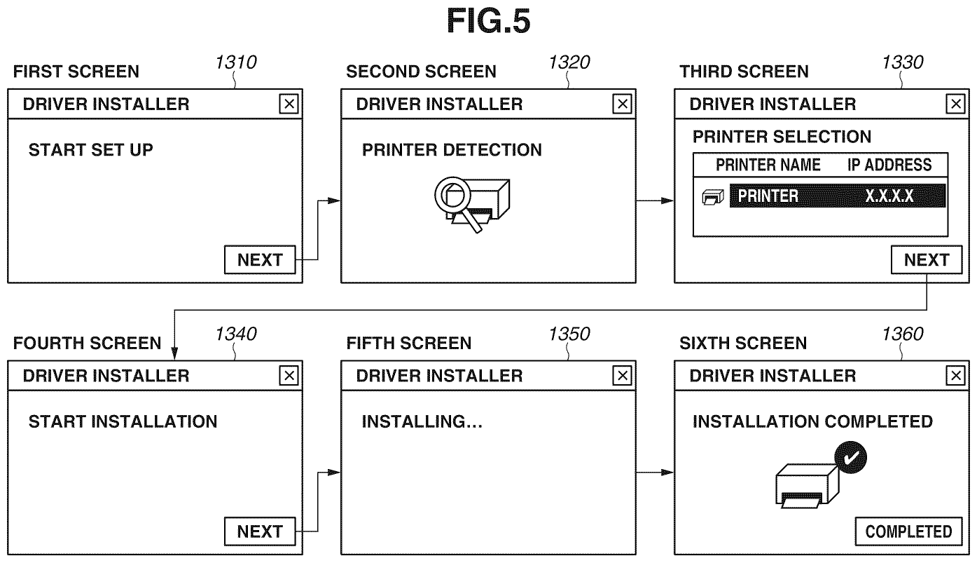

FIG. 5 is a diagram illustrating a transition of screens that are displayed on the display unit 1010 of the computer 1000 by the installer 1210 when the user executes the installer 1210. As a general example, a screen transition in a case where the present disclosure is not implemented will be described.

A first screen 1310 is a screen displayed by the installer 1210 at the time of activation. In response to selection of a “NEXT” button, the installer 1210 displays a second screen 1320. Detection of a printer currently connected to the computer 1000 occurs in the second screen 1320. After detection is completed, the installer 1210 displays a third screen 1330.

The third screen 1330 displays a list of detected printers and prompts the user to select a printer driver to be installed. In response to selection of a “NEXT” button, the installer 1210 displays a fourth screen 1340. The fourth screen 1340 is a screen notifying the user that installation of the driver is to be started. In response to selection of a “NEXT” button, the installer 1210 displays a fifth screen 1350, and starts installation of the driver.

The installation of the driver is performed by the installer 1210 calling an application programming interface (API) for driver installation provided by the driver installation control unit 1111 of the OS 1110.

As part of calling the API, the installer 1210 designates the setup information file 1230 in the driver package 1220.

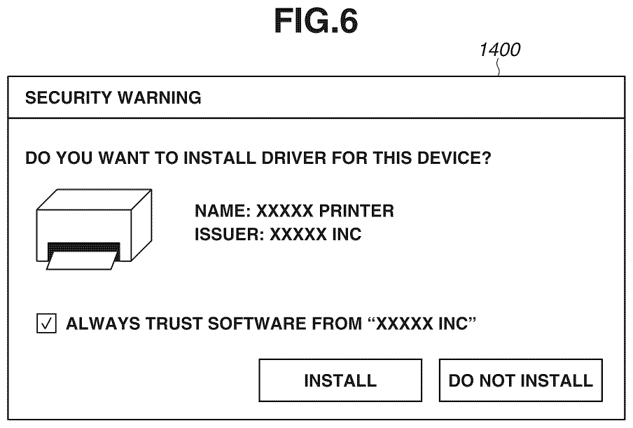

As part of designating the setup information file 1230, a security warning screen may be displayed by the OS 1110 depending on the driver package 1220 to be installed. The security warning screen will be described below with reference to FIG. 6. After completion of the installation of the driver, the installer 1210 displays a sixth screen 1360 to notify the user that the installation has been completed. The processing is then terminated.

FIG. 6 is a diagram illustrating a security warning screen 1400 displayed by the OS 1110 when the driver is installed while the installer 1210 displays the fifth screen 1350.

In a case where the API for driver installation is called, the OS 1110 obtains the file name of the catalog file 1240 described in the setup information file 1230 that has been designated. The OS 1110 refers to the catalog file 1240 having the obtained file name and identifies a certificate corresponding to the digital signature 1241 included in the catalog file 1240.

In a case where the identified certificate is not present in the certificate store 1114 of the OS 1110, the OS 1110 displays the security warning screen 1400. Information on the issuer of the digital signature 1241 is displayed on the security warning screen 1400, and the user is prompted to determine whether the driver with the digital signature 1241 of the issuer is to be installed.

In response to selection of an “INSTALL” button, the OS 1110 starts installation of the driver that has been designated. In response to selection of a “DO NOT INSTALL” button, the OS 1110 cancels installation of the driver.

The security warning screen 1400 also includes a checkbox for a setting whether to always trust a driver with a digital signature of an issuer the same as the issuer of the digital signature 1241. In a case where the setting is on and selection of the “INSTALL” button occurs, the OS 1110 installs (imports) the corresponding certificate in the certificate store 1114. Consequently, the installation may be performed without displaying the security warning screen 1400 in a case where a driver with the same digital signature is installed in subsequent installation.

In a case where selection of the “INSTALL” button occurs with the setting being off, the OS 1110 displays the security warning screen 1400 again in a case where a driver with the same digital signature is installed the next time. As described above, the OS 1110 displays the security warning screen 1400 to the user, thus drivers with signatures signed by suspicious issuers are prevented from being installed without the user's awareness.

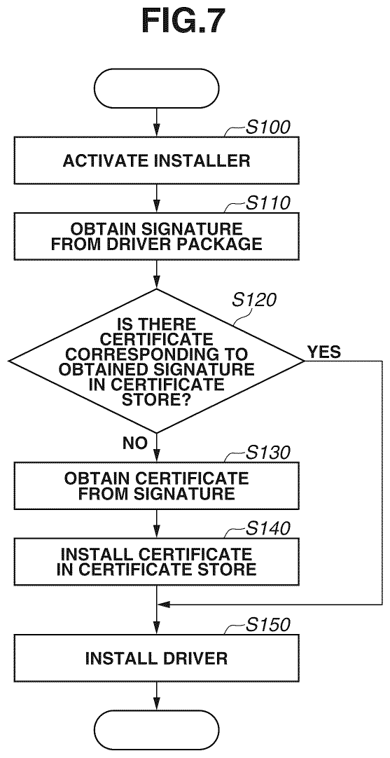

A procedure of installing a driver on the OS 1110 by the installer 1210 according to the first embodiment of the present disclosure will be described with respect to FIG. 7, focusing on the features of the present disclosure. Processing described here is performed by the CPU 1041 executing the installer 1210 stored in the storage unit 1030 in the computer 1000 and loaded into the memory 1042.

In step S100, in response to an activation instruction from the user, the installer 1210 is activated. In step S110, the installer 1210 obtains the digital signature 1241 from the catalog file 1240 included in the driver package 1220.

In step S120, the installer 1210 identifies a certificate from the digital signature 1241 obtained in step S110 and determines whether the identified certificate is in the certificate store 1114. Specifically, the installer 1210 obtains a serial number of the certificate included in the digital signature 1241, and determines whether a certificate having a serial number matching the obtained serial number exists in the certificate store 1114.

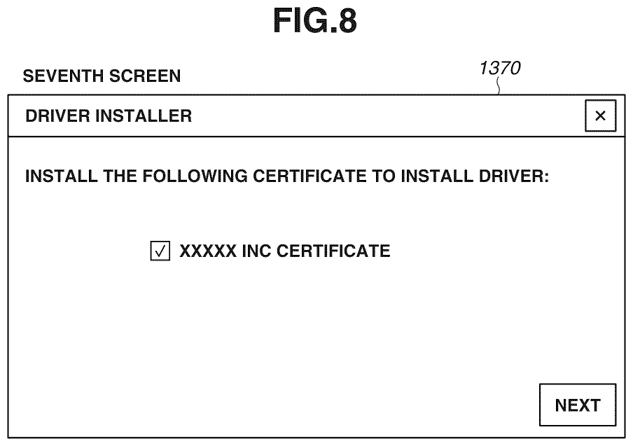

In a case where a certificate corresponding to the digital signature 1241 is not in the certificate store 1114 (NO in step S120), the processing proceeds to step S130. In step S130, the installer 1210 obtains the certificate from the digital signature 1241. In this processing, a seventh screen 1370 illustrated in FIG. 8, which will be described below, is displayed. In a case where a certificate corresponding to the digital signature 1241 is in the certificate store 1114 (YES in step S120), the processing proceeds to step S150.

In step S140, the installer 1210 installs the certificate in the certificate store 1114. Installation of the certificate is performed by the installer 1210 calling an API for certificate installation provided by the certificate management unit 1113 of the OS 1110.

In step S150, the installer 1210 installs the driver on the OS 1110. The procedure of driver installation then ends.

As described above, the driver installation is performed after the certificate for the digital signature 1241 included in the driver package 1220 is installed on the OS 1110 in advance. Thus, the driver may be installed without causing the security warning screen 1400 to be displayed by the OS 1110.

FIG. 8 is a diagram illustrating the seventh screen 1370 displayed by the installer 1210 before installation of the certificate in the certificate store 1114 in the present embodiment.

The installer 1210 displays the seventh screen 1370 illustrated in FIG. 8 between the third screen 1330 and the fourth screen 1340 illustrated in FIG. 5. The seventh screen 1370 is a screen notifying the user that the certificate is to be installed on the OS 1110. A checkbox is provided before issuer information on the certificate. In a case where selection of a “NEXT” button occurs with the checkbox checked, the installer 1210 installs the certificate on the OS 1110 and then displays the fourth screen 1340.

By notifying the user of installation of the certificate before the installation, the certificate is not installed without the user's awareness. By installing the certificate prior to the installation of the driver, the driver is able to be installed without displaying of the security warning screen 1400 illustrated in FIG. 6.

In a case where selection of the “NEXT” button occurs with the checkbox unchecked, the installer 1210 displays the fourth screen 1340 without installing the certificate on the OS 1110. In this case, the security warning screen 1400 illustrated in FIG. 6 is displayed when the driver is installed.

The processing of the installer 1210 according to the present embodiment has been described above. As described in the present embodiment, the installer 1210 operates to install the certificate before the installation of the driver. Consequently, unexpected displaying of the security warning screen 1400 by the OS 1110 in the middle of installation is prevented, thus enabling the user to smoothly install the driver without hesitation.

### Second Embodiment

In the first embodiment, the example case in which a single driver package is included in the installation package 1200 for the driver has been described. In a second embodiment, an example case in which a plurality of driver packages (driver package A 3210 and driver package B 3260) is included in an installation package 3200 for drivers is described. Redundant descriptions of similar processing to the processing in the first embodiment will be omitted herein, and differences will be mainly described.

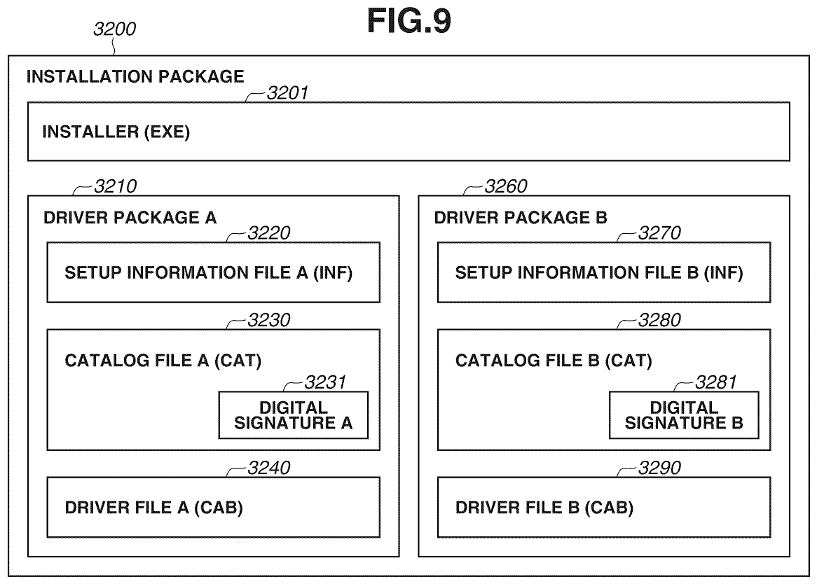

FIG. 9 is a diagram illustrating a file structure of the installation package 3200 for drivers in the second embodiment. The installation package 3200 includes only one installer 3201, which is the same as the configuration according to the first embodiment. Features of a setup information file A 3220, a catalog file A 3230, a digital signature A 3231, and a driver file A 3240 are the same as features of the setup information file 1230, the catalog file 1240, the digital signature A 1241, and the driver file 1250, respectively. Features of a setup information file B 3270, a catalog file B 3280, a digital signature B 3281, and a driver file B 3290 are the same as features of the setup information file 1230, the catalog file 1240, the digital signature A 1241, and the driver file 1250, respectively.

The installation package 3200 includes two driver packages, i.e., the driver package A 3210 and the driver package B 3260. The driver package A 3210 and the driver package B 3260 are, for example, in a case of a multifunction printer, the printer driver and the scanner driver. In the case of the multifunction printer, even though the multifunction printer is one device, the plurality of drivers is prepared, and the plurality of drivers may be collectively installed using the single installer, i.e., the installer 3201.

Three or more driver packages may also be included in the installation package 3200. The user may select one or more drivers to be installed using the installer 3201 from among the plurality of drivers included in the installation package 3200.

Internal configurations of the driver package A 3210 and the driver package B 3260 are the same as the internal configuration of the driver package 1220 according to the first embodiment. In the present embodiment, the catalog file A 3230 of the driver package A 3210 and the catalog file B 3280 of the driver package B 3260 are provided the digital signature A 3231 and the digital signature B 3281, respectively, which are different from each other.

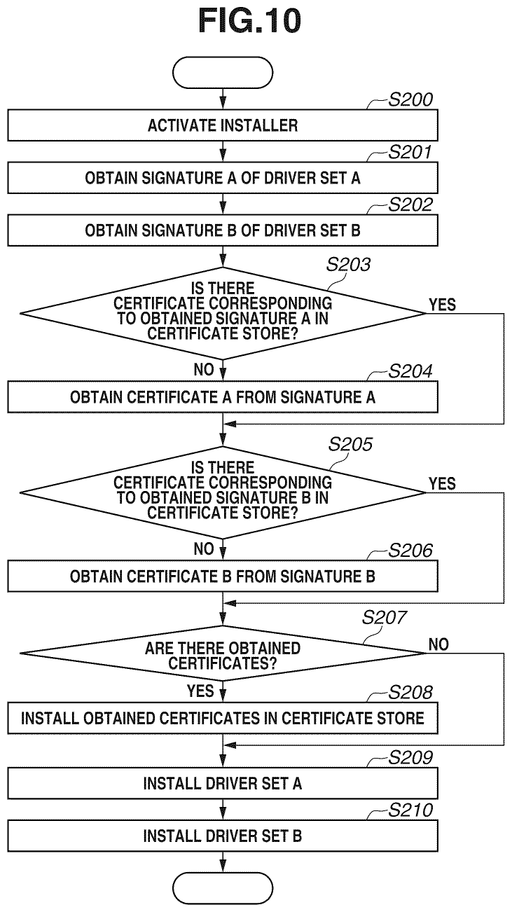

Referring to FIG. 10, a procedure of installing the drivers on the OS 1110 by the installer 3201 according to the present embodiment will be described focusing on the features of the present disclosure. Processing described here is performed by the CPU 1041 executing the installer 3201 that has been stored in the storage unit 1030 in the computer 1000 and is loaded into the memory 1042.

In step S200, in response to an activation instruction from the user, the installer 3201 is activated. In step S201, the installer 3201 obtains the digital signature A 3231 from the catalog file A 3230 included in the driver package A 3210. The obtaining method is the same as the obtaining method according to the first embodiment. In step S202, the installer 3201 obtains the digital signature B 3281 from the catalog file B 3280 included in the driver package B 3260.

In step S203, the installer 3201 identifies a certificate A from the digital signature A 3231 obtained in step S201 and determines whether the certificate A is in the certificate store 1114. In a case where the certificate A corresponding to the digital signature A 3231 is not in the certificate store 1114 (NO in step S203), the processing proceeds to step S204. In step S204, the installer 3201 obtains the certificate A from the digital signature A 3231. In a case where the certificate A corresponding to the digital signature A 3231 is in the certificate store 1114 (YES in step S203), the processing proceeds to step S205.

In step S205, the installer 3201 also identifies a certificate B from the digital signature B 3281 obtained in step 202 and determines whether the certificate B is in the certificate store 1114. In a case where the certificate B corresponding to the digital signature B 3281 is not in the certificate store 1114 (NO in step S205), the processing proceeds to step S206. In step S206, the installer 3201 obtains the certificate B from the digital signature B 3281. In a case where the certificate B corresponding to the digital signature B 3281 is in the certificate store 1114 (YES in step S205), the processing proceeds to step S207.

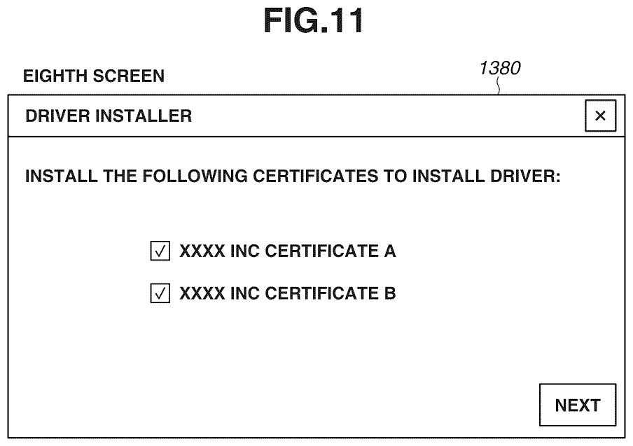

In step S207, the installer 3201 determines whether there is any certificate obtained in steps S204 and S206. In a case where there is any obtained certificate (YES in step S207), the processing proceeds to step S208. In step S208, after an eighth screen 1380 illustrated in FIG. 11 is displayed, the obtained certificates are installed in the certificate store 1114. In a case where there is no certificate obtained in steps S204 and S206 (NO in step S207), the processing proceeds to step S209. In step S209, the installer 3201 installs the driver package A 3210 on the OS 1110. In step S210, the installer 3201 installs the driver package B 3260 on the OS 1110.

FIG. 11 is a diagram illustrating the eighth screen 1380 that is displayed in step S208 before installation of the certificates A and B in the certificate store 1114 by the installer 3201 according to the present embodiment. The installer 3201 displays the eighth screen 1380 illustrated in FIG. 11 between the third screen 1330 and the fourth screen 1340 illustrated in FIG. 5.

Unlike the seventh screen 1370 according to the first embodiment, the user is notified on one screen that two certificates are to be installed. This prevents the certificates from being installed without the user's awareness and the user from experiencing the repeated display of the confirmation screen each time a certificate is to be installed.

In the present embodiment, the processing of the installer 3201 that installs the plurality of drivers has been described. By implementing the present disclosure in this manner, the same effect can be obtained even when the plurality of driver packages (the driver package A 3210 and the driver package B 3260) is installed. In particular, installing a plurality of certificates in the OS 1110 at a time leads to an elimination of the need to notify the user multiple times, which improves the user convenience.

According to the present disclosure, since a certificate corresponding to a signature of a driver is installed before installation of the driver, a confirmation screen is not displayed, thus enabling the driver to be smoothly installed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-122444, filed Jul. 29, 2024, which is hereby incorporated by reference herein in its entirety.

What is claimed is:

1. A non-transitory computer-readable storage medium storing a program that causes an information processing apparatus to perform a method, the program being for installing a driver for controlling a peripheral apparatus on the information processing apparatus, the method comprising:
obtaining a certificate of the driver in a case where the certificate is not installed on the information processing apparatus;
installing the obtained certificate on the information processing apparatus; and
installing the driver in response to installation of the certificate.

2. The non-transitory computer-readable storage medium according to claim 1, the method further comprising notifying a user that certificate installation is to be performed before installation of the certificate.

3. The non-transitory computer-readable storage medium according to claim 1, wherein the certificate is a certificate corresponding to a digital signature included in a driver package for the driver.

4. The non-transitory computer-readable storage medium according to claim 1, wherein installing the certificate causes the certificate to be stored in a certificate store of the information processing apparatus.

5. The non-transitory computer-readable storage medium according to claim 1, wherein the method further comprises:
collectively installing a plurality of drivers,
obtaining a plurality of certificates corresponding to respective digital signatures each included in a corresponding driver package of driver packages of the plurality of drivers, and
installing the plurality of certificates on the information processing apparatus.

6. A method for installing a driver for controlling a peripheral apparatus on an information processing apparatus, the method comprising:
obtaining a certificate of the driver in a case where the certificate is not installed on the information processing apparatus;
installing the obtained certificate on the information processing apparatus; and
installing the driver in response to installation of the certificate.

7. The method according to claim 6, further comprising notifying a user that certification installation is to be performed before installation of the certificate.

8. The method according to claim 6, wherein the certificate is a certificate corresponding to a digital signature included in a driver package for the driver.

9. The method according to claim 6, wherein installing the certificate causes the certificate to be stored in a certificate store of the information processing apparatus.

10. The method according to claim 6, further comprising:
collectively installing a plurality of drivers,
obtaining a plurality of certificates corresponding to respective digital signatures each included in a corresponding driver package of driver packages of the plurality of drivers, and
installing the plurality of certificates on the information processing apparatus.

11. An information processing apparatus comprising:
a memory storing a program; and
a processor that, when executing the program, is caused to:
obtain, in a case where the certificate is not installed on the information processing apparatus, a certificate of a driver for controlling a peripheral apparatus;
install the obtained certificate on the information processing apparatus; and
install the driver based on installation of the certificate.
